(19) United States
(12) Patent Application Publication
(10) Pub. No.: US 2011/0306029 A1
(43) Pub. Date: Dec. 15, 2011

(54) ONLINE BASED STUDENT PEER MENTORING PROGRAM

(76) Inventor: Flavian Prince, Chicago, IL (US)

(21) Appl. No.: 12/816,235

(22) Filed: Jun. 15, 2010

(51) Int. Cl. G09B 5/00

(52) U.S. Cl. 434/350

(57) ABSTRACT

A method and system for offering an on-line based student peer mentoring program sponsored by at least one school and operated by at least one student apprentice and at least one student mentor, using a social networking website which facilitates a student participant to access a plurality of training web link modules to first be trained by a student peer mentor of more advanced training, and then to train at least one student peer protégé of less advanced training. The goal is for the student participant to become a mentor and then an apprentice for at least one business owner, and for the student apprentice to establish a relationship with another school to join the on-line based student peer mentoring program. The plurality of training web link modules includes instruction and training relating to academic curriculum, a literacy program and a social curriculum.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to on-line based mentoring programs, and more particularly, to a method and system for offering an on-line based student peer mentoring program run by an agency, and sponsored by at least one school, in which at least one participant uses a social networking website which facilitates the participant to access a plurality of training web link modules to first be trained by a student peer of more advanced training, and then to train at least one student peer of less advanced training, with the goal that the participant become an apprentice for at least one business and commence another on-line based student peer mentoring program sponsored by another school.

Regular educational institutions can lack a suitable instructor or an effective method for teaching students a particular subject. The utilization of learning aids can often be an effective method for bridging this gap. Types of learning aids include class-room instruction, CDs, magazines and books. Students are compelled to study the pre-determined topics on a set schedule and pace in schools. CDs and magazines do not provide any degree of feedback correction for mispronunciation or poor grammar. More recently, on-line based software programs have been available for teaching and learning purposes. On-line based mentoring programs can assist students to easily find an able, experienced and effective mentor. These programs also allow students to acquire knowledge in both social and academic topics.

There are a variety of known methods and systems for offering an on-line based mentoring program to a participant. A computer-implemented method for bi-directionally matching a protégé and a mentor among participants in an on-line environment has been described in U.S. Pat. Application No. 20060031087 by Fox. The method includes registering the protégé so that he or she can be uniquely identified within the on-line environment. A mentor profile is received including demographic and/or personal information about the mentor, as well as the mentor's preferences regarding potential protégés. A protégé profile is also received including demographic and/or personal information about the protégé as well as the protege's preferences regarding potential mentors. One or more recommended mentor-protégé matches are bi-directionally calculated based on the information and preferences. One or more coaching prompts and evaluation requests are sent to the matched participants.

U.S. Pat. Application No. 20060253572 by Gomez discloses a platform that allows the complete development and management of an on-line mentoring program. This includes a hierarchical administration system, a user management with custom data fields stored for each user type, a project-based mentor and student participation component tools to track program participation. The system stores and manages the hierarchical structure in a relational database management system. One of the unique aspects of this design is that it allows a complete separation of programs by client, and allows hierarchies of any size with no appreciable degradation in performance of the system.

U.S. Pat. No. 6,062,862 issued to Koskinen discloses a user method and system for accessing mentor experience information in a knowledge-based user educational guidance system. The system will access, store, compile and transfer mentor experience information to financial services. The method includes the steps of providing a graphical user interface for introducing and navigating throughout the knowledge based system, providing a set of alternative learning paths which require interactive user participation in accordance with the mentor experience information, providing means for the user to interactively select a desired learning path based on user interest and demonstrated performance, providing contextual case based explication and application of the mentor knowledge and experience directed to financial services, providing a set of interactive multi-tiered valid use simulations of application of the knowledge in accordance with the knowledge based system, providing interactive means for mentoring the user when, as, and if user learning guidance is required, and providing consequential feedback for the user based on user responses to the mentoring.

All of the systems and methods for providing an on-line based mentoring program to participants discussed above involve the matching of a student with a mentor among the participants in an on-line environment. In some methods, the web based learning system includes a pre-determined list of learning systems and training software modules which are designed to train and develop literacy and knowledge in different subjects. The participants spend hours working through these lists of learning systems. These systems do not provide for feedback from the participants through blogging or email, for example. These systems do not allow the participants to upload their ideas, articles, or pictures to the websites. Some of the conventional methods and systems do not measure or track the responses or progress of the participants. Some systems do not have a structural arrangement which is economical for both the participants and mentors, since none of these systems provide any scholarships to the participants while they achieve a certain skill level. In some methods, the training does not allow the participants and mentors to accomplish a business goal.

Therefore, an object of the present invention is to provide a method and system for offering an on-line based student peer mentoring program sponsored by at least one school and operated by at least one participant (“apprentice”) using a social networking website which allows at least one participant (“mentor”) to access a plurality of training web link modules to train at least one student peer (“protégé”). One object of the invention is that trained participants can choose a group of protégés (“quilombo”) from a nearby school and provide training using the plurality of training web link modules in the website. Another object of the invention is that the Agency that operates the on-line system provides scholarship funds when the participants or mentors apply for an apprenticeship to at least one business owner. Yet another object of the invention is that the participants and the selected protégés can achieve a certain skill level to become a mentor. Other objects of the present invention will become better understood with reference to appended Summary, Description and Claims.

### SUMMARY

The present invention is a method and system for offering an on-line based student peer mentoring program sponsored by at least one school and operated by at least one student participant using a social networking website which facilitates the student participant to access a plurality of training web link modules to first be trained by a student peer mentor of more advanced training, and then to train at least one student peer protégé of less advanced training, with the goal that the at least one student participant become an apprentice for at least one business and commence another on-line based student peer mentoring program for another school.

The training is done both in-person and online. Once trained, the mentor is matched up with at least one peer student identified by a school as needing educational assistance, and who falls within a category of persons to be trained (e.g., 3^{rd} to 8^{th} grade). The person to be trained is called the protégé and the protégé is instructed by the mentor to register with a website of the online student peer mentoring program so that online training can commence. A personalized web page is generated for the protégé that corresponds to the mentor. The personalized web page includes personal information, pictures, and a calendar, and the protégé can blog their reflective writing assignments through the curriculum set by the mentor. The school provides financial compensation and resources such as computers, the internet, printers, classroom space, and an adult supervisor, in exchange for the online training.

The website allows the participant to register into the website by entering at least one requested information and creating a user account. The plurality of training web link modules includes instruction and training relating to academic curriculum, a literacy program and a social curriculum.

A mentor may train a plurality of protégés, including students in other countries. Several mentors may train a plurality of protégés in one school, and form a group. A mentor himself may be a protégé to another of more advanced training.

Each protégé is given points for attendance, behavior, completed and turned in assignments, and for effort. The points are recorded in the calendar to monitor the progress of the student protégé or the group. The points can be viewed by all participants in the online based student peer mentor program to promote competition. The progress can also be viewed by the protégé's school.

The mentor submits an evaluation report for the school to monitor a protégé's literacy and social growth, which can be accessed by the school through the personalized web page of the protégé.

When a mentor reaches a level of sufficiently advanced training, the mentor's school approves the mentor for applying for an apprenticeship to at least one business owner. When a mentor becomes an apprentice with a business owner, the apprentice starts another online based student peer mentorship program with another school.

### BRIEF DESCRIPTION OF THE FIGURES

FIG. 1 is a diagrammatic representation of a system and method according to the present invention offering an on-line based student peer mentoring program sponsored by at least one school, operated by at least one student apprentice, and comprising at least one student mentor and at least one student protégé using a social networking website facilitating the at least one student participant to access a plurality of training web link modules.

FIG. 2 is an exemplary web page illustrating participants registered in the website and the plurality of training web link modules.

FIGS. 3 and 4 are exemplary web pages illustrating the functionality of the plurality of training web link modules.

### REFERENCE NUMERALS

10 . . . Diagrammatic representation of a method and system according to the present invention

12 . . . At least one school

14 . . . Agency

16 . . . At least one student participant

18 . . . Plurality of training web link modules

20 . . . Plurality of student protégés

22 . . . At least one business owner

### DETAILED DESCRIPTION

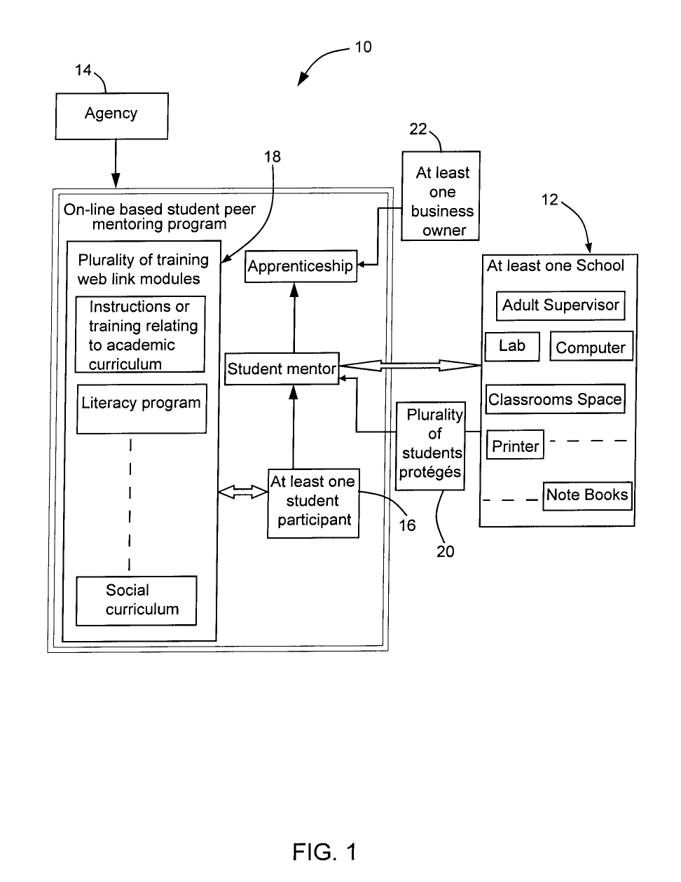

Referring to the drawings, a preferred embodiment illustrates a method and system for offering an on-line based student peer mentoring program run by an agency 14, and sponsored by at least one school 12 in which at least one student participant 16 uses a social networking website which facilitates the at least one student participant 16 to access a plurality of training web link modules 18 to first be trained by a student peer of more advanced training, and then to train at least one student peer of less advanced training, with the goal that the at least one student participant 16 become an apprentice for at least one business and commence another on-line based student peer mentoring program sponsored by another school, and generally indicated in FIGS. 1 through 4.

Referring to FIG. 1, the major components that facilitate the system and method for offering an on-line based student peer mentoring program sponsored by at least one school 12, operated by at least one student apprentice and comprising at least one student mentor and at least one student protégé are shown in a diagrammatic illustration 10. The social networking website allows the at least one student participant 16 to register into the website by entering at least one requested information and creating a user account. The plurality of training web link modules 18 includes instruction and training relating to academic curriculum, a literacy program and a social curriculum. The at least one student participant 16 obtains academic training from at least one student mentor, including utilizing the plurality of training web link modules 18 in the social networking website.

The training elevates the least one student participant 16 to achieve a skill level to become a student mentor for at least one student protégé. The training is done both in-person and online. Once trained, a student apprentice of the on-line based student peer mentoring system enters into an agreement with at least one school 12 to offer the on-line based student peer mentoring program to a plurality of student protégés 20 identified by the at least one school 12 as being in need of educational assistance and who falls within a category of persons to be trained (e.g., 3^{rd} to 8^{th} grade). The student mentor has completed training in a given subject or has successfully completed a grade level above that of the plurality of student protégés 20. The student mentor has completed a grade level above grade 7 and the plurality of student protégés 20 have completed a grade level above grade 3 but below grade 8. The student mentor may be a college student.

The at least one school 12 provides financial compensation and educational resources such as computers, the internet, printers, and classroom space, and an adult supervisor, in exchange for the on-line based student peer mentoring program. The student apprentice provides a plurality of student mentors for the plurality of student protégés 20. The student mentors and the plurality of student protégés 20 are matched up based upon a relatable subject matter, on a one-on-one basis or gender basis. The plurality of student protégés 20 is instructed by the student mentor to register with the social networking website of the on-line based student peer mentoring program so that on-line training can commence. A personalized web page is generated for the plurality of student protégés 20 that corresponds to the student mentor used for training and for tracking the progress of the plurality of student protégés 20. The personalized web page used for training includes personal information, pictures, calendar, emails, forums, the ability to upload papers, art projects, athletic statistics, and video files, the ability to request transcripts and official records. The protégé can blog their reflective writing assignments through the curriculum set by the student mentor.

After the at least one student participant 16 becomes the student mentor, the at least one student participant 16 provides training to the plurality of student protégés 20, or to one protégé on a one-on-one basis, including utilizing the plurality of training web link modules 18. Each protégé is given points for attendance, behavior, completed and turned in assignments, and for effort. The points are recorded in the calendar to monitor the progress of the plurality of student protégés 20. The points can be viewed by all participants in the online based student peer mentoring program to promote competition. The progress can also be viewed by the protégés school, community members, churches, museums, corporations, and others who register with the social networking website.

The student mentor submits an evaluation report of the plurality of student protégés 20, or for an individual protégé if assignment of the protégé and mentor is made on a one-on-one basis, for the at least one school 12. The evaluation report can be accessed by the at least one school 12 through the personalized web page of the plurality of student protégés 20 to monitor the progress of the plurality of the student protégés 20 in literacy and social growth. After the student mentor has trained the plurality of student protégés 20, the student mentor may apply for an apprenticeship through the on-line based student peer mentoring program, to at least one business owner 22 by submitting a proposal that includes a resume and personal information stored in the user account and/or in a DVD. When the student mentor becomes the apprentice with a business owner 22, the apprentice starts another on-line based student peer mentoring program with another school, wherein the plurality of student protégés 20 can also achieve a skill level to become a student mentor and a student apprentice through the on-line based student peer mentoring program.

The on-line based student peer mentoring program is administered by a non-profit agency 14 that counsels the student apprentice in operating the on-line based student peer mentoring program and assists the student apprentice in locating a business owner 22 to perform an apprenticeship. The non-profit agency 14 provides a scholarship amount to the at least one student mentor to become a student apprentice for at least one business owner 22. The scholarship amount is automatically deposited in an account of the student mentor which may be viewed in the personalized web page of the student mentor by both the student mentor and the at least one business owner 22. The student apprentice has duties that include facilitating the set up of the on-line based student peer mentoring program, choosing the curriculum, addressing all technical aspects of the on-line based student peer mentoring program, and briefing student mentors on training issues.

In geographic areas in which one school performs well, and another school does not, a student apprentice or a group of student mentors may be provided by a well-performing school, and the student protégés may be supplied by a school with poor performance in order to improve the overall academic performance of the poor performing school.

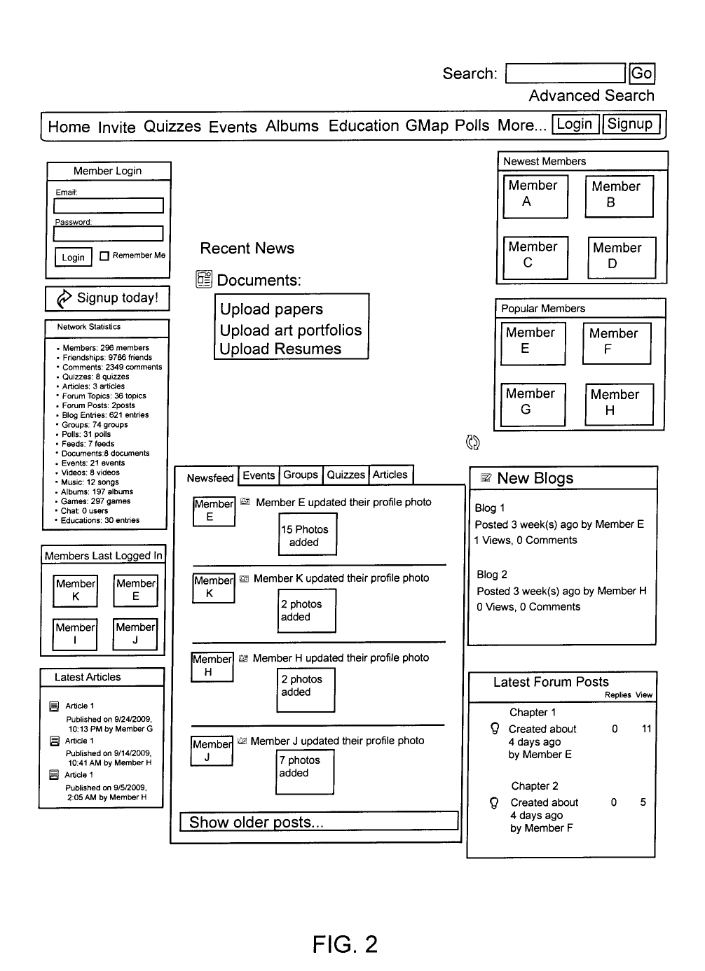

FIG. 2 is an exemplary web page illustrating participants registered in the website and the plurality of training web link modules 18. The plurality of training web link modules 18 includes instruction and training relating to academic curriculum, a literacy program and a social curriculum such as quizzes, albums, and polss. This web page, used for training, includes personal information, pictures, calendar, emails, forums, the ability to upload papers, art projects, athletic statistics, and video files, the ability to request transcripts and official records and the protégé can blog their reflective writing assignments through the curriculum set by the student mentor. The web page allows the at least one student participant to send invitations to their friends and encourage them join the on-line based student peer mentoring program. The web page also displays a Gmap (Google Map) that facilitates the at least one student participant 16 to locate and retrieve the information regarding the participants registered in the website.

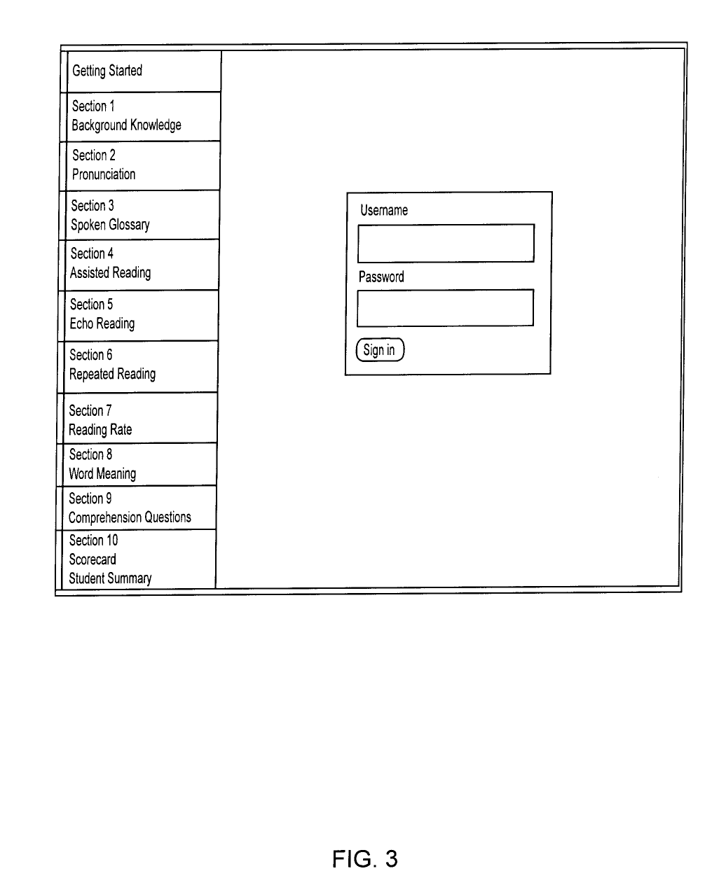

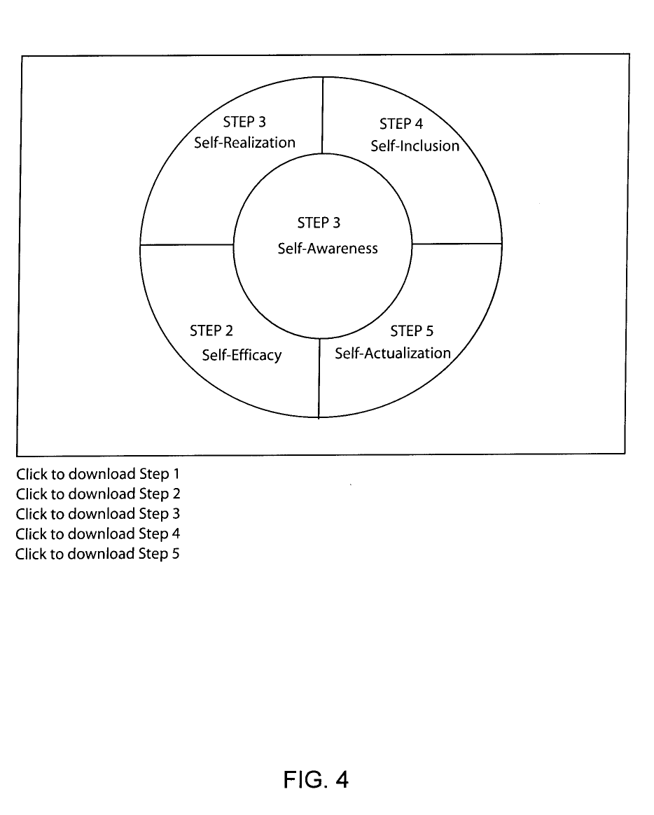

FIGS. 3 and 4 are exemplary web pages illustrating the functionality of the plurality of training web link modules 18 in the website. The at least one student participant 16 can be trained by using the plurality of web link modules 18. The at least one student participant 16 can select a plurality of hyperlinks that describes the different steps including social and academic topics which may be utilized for the training plan of the at least one student participant 14. The training on the first three steps allows the at least one student participant 14 to achieve a skill level to become a student mentor and the training on the fourth step allows the student mentor to apply for an apprenticeship.

To promote community participation, the social networking website may also allows community members, churches, schools, museums, corporations, and others who register with the social networking website, to advertise, post events, and create discussion topics for the social networking website.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A system and method for offering an on-line based student peer mentoring program sponsored by at least one school, operated by at least one student apprentice, and comprising at least one student mentor and at least one student protégé, the system and method further comprising:
a social networking website facilitating at least one student participant to access a plurality of training web link modules, the website allowing the at least one student participant to
register into the website by entering at least one requested information and creating a user account; and
obtain academic training from at least one student mentor, including utilizing the plurality of training web link modules, wherein the at least one student participant can achieve a skill level to become a student mentor for at least one student protégé;
a student apprentice of the on-line based student peer mentoring program enters into an agreement with at least one school to offer the on-line based student peer mentoring program to a plurality of student protégés identified by the at least one school as being in need of educational assistance, wherein the at least one school provides financial compensation and educational resources for the on-line based student peer mentoring program and the student apprentice provides a plurality of student mentors for the plurality of student protégés;
the plurality of student protégés register into the website to generate a personalized web page used for training and for tracking the progress of the plurality of student protégés;
after the at least one student participant becomes a student mentor, the at least one student participant provides training to at least one student protégé, including utilizing the plurality of training web link modules;
the at least one student mentor submits an evaluation report of the at least one student protégé to be viewed by the at least one school;
the at least one school accesses the evaluation report of the plurality of student protégés through the personalized web page to monitor the progress of the plurality of student protégés; and
after the at least one student participant has trained a plurality of student protégés, the at least one student participant may apply for an apprenticeship, through the on-line based student mentoring program, to at least one business owner by submitting a proposal that includes a resume and personal information stored in a user account and/or in a DVD;
whereby the plurality of student protégés can also achieve a skill level to become a student mentor and a student apprentice through the on-line based student mentoring program.

2. The system and method of claim 1, wherein the on-line based student peer mentoring program is administered by a non-profit agency that counsels the at least one student apprentice in operating the on-line based student peer mentoring program and that assists the at least one student apprentice in locating a business owner to perform an apprenticeship.

3. The system and method of claim 2, wherein the non-profit agency provides a scholarship amount to the at least one student mentor to become a student apprentice for at least one business owner.

4. The system and method of claim 3, wherein the scholarship amount is automatically deposited in an account of the at least one student mentor which may be viewed in the personalized web page of the student mentor by both the student mentor and the at least one business owner.

5. The system and method of claim 1, wherein the at least one student apprentice has duties that include facilitating the set up of the on-line student peer mentoring program, choosing the curriculum, addressing all technical aspects of the on-line student peer mentoring program, and briefing student mentors on training issues.

6. The system and method of claim 1, wherein the at least one student apprentice and the at least one student mentor is supplied by a school other than the one that supplies the plurality of student protégés to improve the overall academic performance of the school supplying the plurality of student protégés.

7. The system and method of claim 6, wherein the school, other than the one that supplies the plurality of student protégés, and the school supplying the plurality of student protégés are in the same local region.

8. The system and method of claim 1, wherein the at least one student mentor and the at least one student protégé are matched up based upon a relatable subject matter.

9. The system and method of claim 1, wherein the at least one student mentor and the at least one student protégé are matched up on a one-on-one basis.

10. The system and method of claim 1, wherein the at least one student mentor and the at least one student protégé are matched up based on gender.

11. The system and method of claim 1, wherein the plurality of training web link modules comprise instruction or training relating to academic curriculum, a balanced literacy program and a social curriculum.

12. The system and method of claim 1, wherein the at least one student mentor has completed training in a given subject or has successfully completed a grade level above that of the at least one student protégé.

13. The system and method of claim 12, wherein the at lease one student mentor has completed a grade level above grade 7 and the at least one student protégé has completed a grade level above grade 3 but below grade 8.

14. The system and method of claim 13, wherein the at least one student mentor is a college student.

15. The system and method of claim 1, wherein the educational resources include computers, access to the internet, classroom space, printers, and an adult supervisor.

16. The system and method of claim 1, wherein the personalized web page used for training includes blogs, calendars, email, chat rooms, forums, the ability to upload papers, art projects, athletic statistics, and video files, the ability to request transcripts and official records.

17. The system and method of claim 1, wherein the personalized web page used for tracking the progress of the plurality of students comprises a calendar on which points are assigned to student protégés for attendance, behavior, completed and turned in assignments, and for effort, and in which the calendar can be viewed by other student protégés and the student protégé's school, and wherein progress can be monitored on the calendar on an individual basis among students assigned to a mentor or on a group basis between students of different schools.

18. The system and method of claim 17, wherein the personalized web page used for tracking the progress of the plurality of students can be viewed by community members, churches, schools, museums, corporations, and others who register with the social networking website.

19. The system and method of claim 1, wherein the at least one student participant applies for an apprenticeship after having been approved for applying for an apprenticeship by the student participant's school.

20. A system and method for offering an on-line based student peer mentoring program sponsored by at least one school, operated by at least one student apprentice, and comprising at least one student mentor and at least one student protégé, the system and method further comprising a social networking website that allows community members, churches, schools, museums, corporations, and others who register with the social networking website, to advertise, post events, and create discussion topics for the social networking website.
